(19) United States
(12) Patent Application Publication
(10) Pub. No.: US 2012/0259618 A1
(43) Pub. Date: Oct. 11, 2012

(54) COMPUTING DEVICE AND METHOD FOR COMPARING TEXT DATA

(75) Inventors: CHUNG-I LEE, Tu-Cheng (TW); HAI-HONG LIN, Shenzhen City (CN); DE-YI XIE, Shenzhen City (CN); SHUAI-JUN TAO, Shenzhen City (CN); ZHI-QIANG YI, Shenzhen City (CN); AN-SHENG LUO, Shenzhen City (CN); WEI JIANG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/340,705

(22) Filed: Dec. 30, 2011

(30) Foreign Application Priority Data
Apr. 6, 2011 (CN) 201110084821.4

(51) Int. Cl. G06F 17/27

(52) U.S. Cl. 704/9

(57) ABSTRACT

A method for comparing text data reads two patent documents comprising varying text sections. The method compares characters of a first text section in a first patent document with a corresponding second text section in a second patent document, and acquires a same sub-character string that has a maximum matching length and matching positions of the first and second text sections. The method marks characters before the matching positions of the first and second text sections as different characters. The method displays a comparison result list of the comparison between the first patent document and the second patent document on a display device.

### BACKGROUND

1. Technical Field

Embodiments of the present disclosure generally relate to data analysis technology, and more particularly to a computing device and a method for comparing text data.

2. Description of Related Art

Existing methods for comparing text data may search differences of two documents, but cannot intuitively display the differences to users. Particularly when there is a great deal of data in the two documents, it is a waste of time and inconvenient for the users to read the differences.

### BRIEF DESCRIPTION OF THE DRAWINGS

FIG. 1 is a block diagram of one embodiment of a computing device including a comparison unit for comparing text data.

FIG. 2 is a schematic diagram of one embodiment of a comparison result list.

FIG. 3 is a flowchart of one embodiment of a method for comparing text data.

FIG. 4 is a flowchart detailing step S12 in FIG. 3.

### DETAILED DESCRIPTION

The application is illustrated by way of examples and not by way of limitation in the figures of the accompanying drawings in which like references indicate similar elements. It should be noted that references to “an” or “one” embodiment in this disclosure are not necessarily to the same embodiment, and such references mean at least one.

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

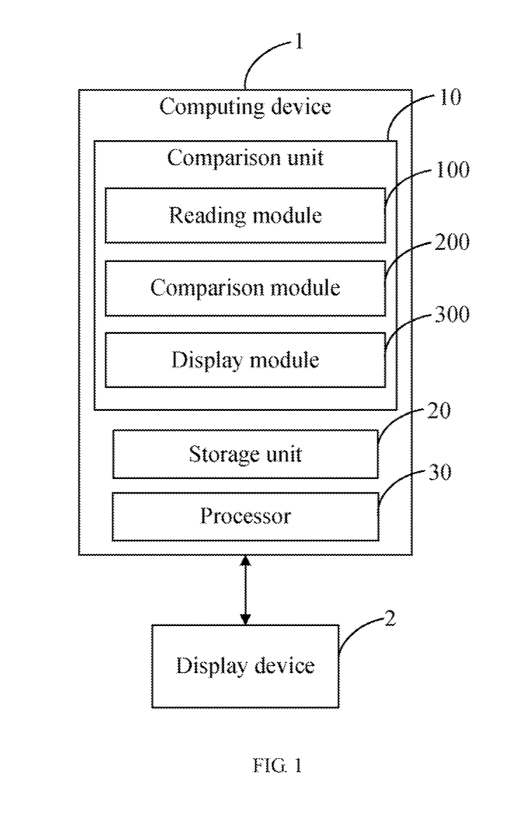

FIG. 1 is a block diagram of one embodiment of a computing device 1 including a comparison unit 10 for comparing text data. The computing device 1 further includes a storage unit 20 and a processor 30, and electrically connects to a display device 2.

In the embodiment, the comparison unit 10 is operable to compare the text data of two patent documents. The display device 2 displays the two patent documents and differences between the two patent documents. It is understood that in other embodiments, the comparison unit 10 can be operable to compare the text data of other documents in varying formats.

In one embodiment, the comparison unit 10 may include one or more function modules (a description is given in FIG. 1). The one or more function modules may comprise computerized code in the form of one or more programs that are stored in the storage unit 20, and executed by the processor 30 to provide the functions of the comparison unit 10. The storage unit 20 may be a cache or a dedicated memory, such as an EPROM or a flash memory.

In one embodiment, the comparison unit 10 includes a reading module 100, a comparison module 200, and a display module 300.

The reading module 100 reads the a first patent document and a second patent document. The two patent documents may both have varying text data, such as data about application number information, application date information and inventor information of a patent. A section of the text data in the two patent documents, such as the application number information or the application date information of the patent, is regarded as a text section. A patent document may have varying text sections. In one embodiment, the two patent documents may be in WORD, PDF, or XML format.

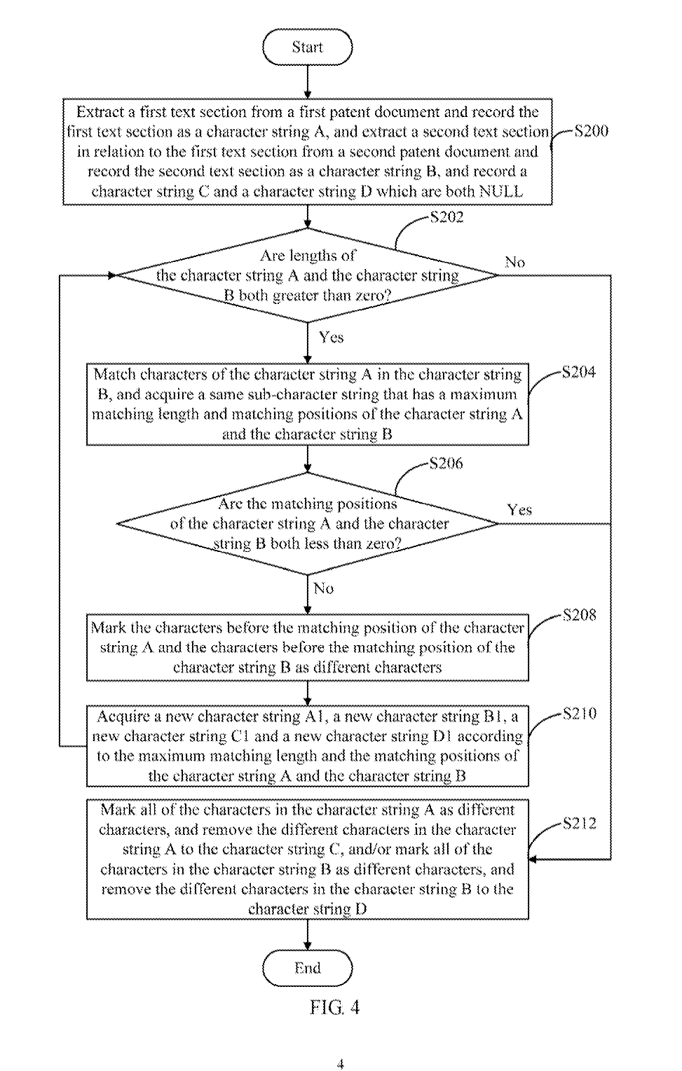

The comparison module 200 compares each text section in the first patent document with corresponding text section in the second patent document, and marks different characters between the two documents. In one embodiment, a text section in the first patent document and the corresponding text section in the second patent document are about the same information. For example, if the text section in the first patent document is about the inventor information of the patent, the corresponding text section in the second patent document is about the inventor information of the patent too. The comparison module 200 can find out the corresponding text section in the second patent document according to a key word “inventor”. In one embodiment, the different characters can be marked in bold type, in italic type, or in color. A detailed procedure is given in FIG. 4.

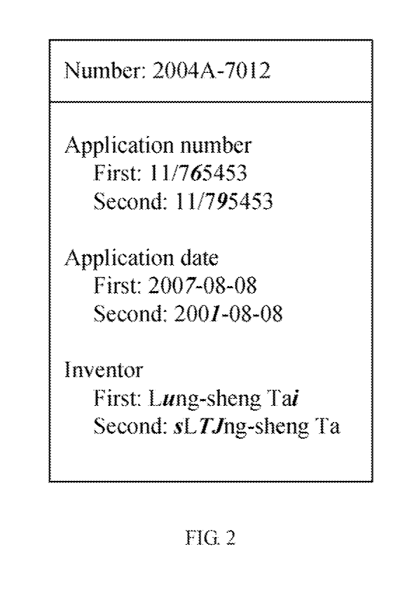

The display module 300 displays a comparison result list of the first patent document and the second patent document on the display device 2 (as shown in FIG. 2). The comparison result list includes all of the text data compared between the first patent document and the second patent document with the marked different characters. In one embodiment, the comparison result list is displayed through a web page.

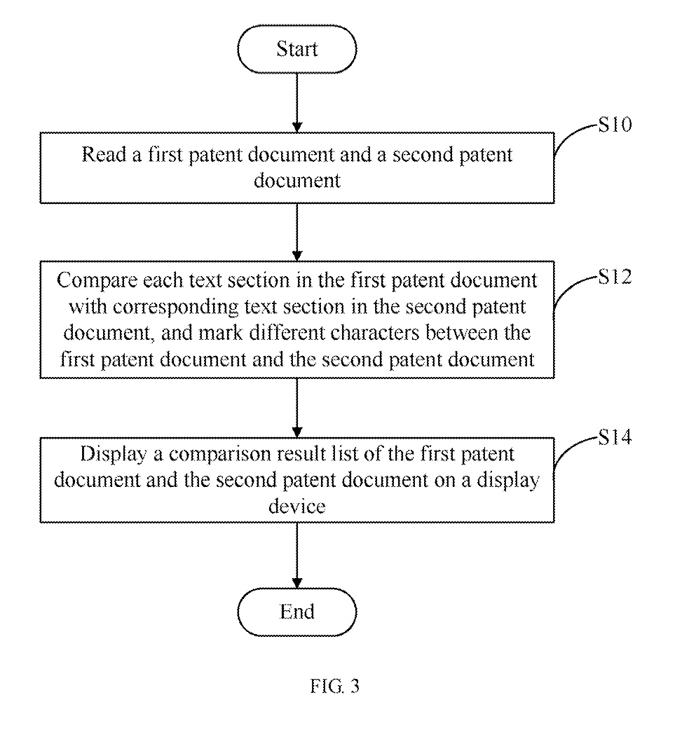

FIG. 3 is a flowchart of one embodiment of a method for comparing text data. Depending on the embodiment, additional steps may be added, others removed, and the ordering of the steps may be changed.

In step S10, the reading module 100 reads the first patent document and the second patent document.

In step S12, the comparison module 200 compares each text section in the first patent document with corresponding text section in the second patent document, and marks the different characters between the first patent document and the second patent document. A detailed procedure is given in FIG. 4.

In step S14, the display module 300 displays a comparison result list of the first patent document and the second patent document on the display device 2 (as shown in FIG. 2). The comparison result list includes all of the text data compared between the first patent document and the second patent document with the marked different characters.

FIG. 4 is a flowchart detailing step S12 in FIG. 3.

In step S200, the comparison module 200 extracts a first text section (such as the inventor information of the patent) from the first patent document and records the first text section as a character string A, and extracts a second text section in relation to the first text section (the inventor information of the patent) from the second patent document and records the second text section as a character string B, and records a character string C and a character string D which are both NULL.

In step S202, the comparison module 200 determines whether a length of the character string A and a length of the character string B are both greater than zero. In the embodiment, the length is a number of characters in the character string A or the character string B. If both of the lengths of the character string A and the character string B are greater than zero, step S204 is implemented. If the length of at least one of the two character strings is zero, step S212 is implemented.

In step S204, the comparison module 200 matches the characters of the character string A in the character string B, and acquire a same sub-character string that has a maximum matching length and matching positions of the character string A and the character string B. The character string A and the character string B may include one or more the same sub-character strings, and the acquired sub-character string having the maximum matching length is the sub-character string having the most matching characters. For example, the character string A is “520091222”, and the character string B is “200912230”, thus the two character strings contain the same sub-character string “2009122” that has the maximum matching length seven. The matching position of the character string A is a position of the first one of the matched characters in the character string A. The matching position of the character string B is a position of the first one of the matched characters in the character string B. In the embodiment, the position of the first character in a character string is regarded as zero, and the position of the second character in the character string is regarded as one. For example, the matching position of the character string A “520091222” is one, and the matching position of the character string B “200912230” is zero. If any character contained by the character string A does not exist in the character string B, the matching positions of the character string A and the character string B are regarded as less than zero.

In the embodiment, the comparison module 200 matches a first character of the character string A in the character string B. If the first character of the character string A exists in the character string B, the comparison module 200 continues to match the first character and a second character of the character string A in the character string B, until a next character of the character string A does not exist in the character string B. If the first character of the character string A does not exist in the character string B, the comparison module 200 matches the second character of the character string A in the character string B. For example, the first character “5” of the character string A “520091222” does not exist in the character string B “200912230”, the comparison module 200 matches the second character “2” of the character string A in the character string B. The second character “2” exists in the character string B, the comparison module 200 continues to match the second character and the third character “20” of the character string A in the character string B, until the characters “20091222” of the character string A does not exist in the character string B.

In step S206, the comparison module 200 determines whether the matching positions of the character string A and the character string B are both less than zero. If the matching positions of the character string A and the character string B are both less than zero, step S212 is implemented. If at least one of the matching positions of the character string A and the character string B is not less than zero, step S208 is implemented.

In step S208, the comparison module 200 marks the characters before the matching position of the character string A and the characters before the matching position of the character string B as different characters. For example, the comparison module 200 marks the character “5” before the matching position one of the character string A “520091222” in bold and italic type.

In step S210, the comparison module 200 acquires a new character string A1, a new character string B1, a new character string C1 and a new character string D1 according to the maximum matching length and the matching positions of the character string A and the character string B. In the embodiment, the new character string A1 is the characters that follow the matched characters in the character string A. The new character string B1 is the characters that follow the matched characters in the character string B. The new character string C1 is the character string C adding the different characters and the matched characters in the character string A. The new character string D1 is the character string D adding the different characters and the matched characters in the character string B. In the above-mentioned example, the new character string A1 is “2”, the new character string B1 is “30”, the new character string C1 is “52009122”, and the new character string D1 is “2009122”. Then the procedure returns to the step S202.

In step S212, the comparison module 200 marks all of the characters in the character string A as different characters, and removes the different characters in the character string A to the character string C, and/or marks all of the characters in the character string B as different characters, and removes the different characters in the character string B to the character string D. If both of the lengths of the character string A and the character string B are zero, the procedure ends.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A method being processed by a processor of a computing device, the method comprising:
(a) comparing characters of a first text section in a first patent document with a corresponding second text section in a second patent document, and acquiring a same sub-character string that has a maximum matching length and matching positions of the first and second text sections, and marking characters before the matching positions of the first and second text sections as different characters; and
(b) displaying a comparison result list of the comparison between the first patent document and the second patent document on a display device.

2. The method as claimed in claim 1, wherein the step (a) comprises:
(a1) extracting the first text section recorded as a character string A from the first patent document, and extracting the corresponding second text section recorded as a character string B from the second patent document, and recording a character string C and a character string D which are both NULL;
(a2) matching characters of the character string A in the character string B in response that both of the lengths of the character string A and the character string B are greater than zero, and acquiring the same sub-character string that has the maximum matching length and matching positions of the character string A and the character string B;
(a3) marking the characters before the matching position of the character string A and the characters before the matching position of the character string B as different characters, in response that at least one of the matching positions of the character string A and the character string B is not less than zero;
(a4) acquiring a new character string A1, a new character string B1, a new character string C1 and a new character string D1 according to the maximum matching length and the matching positions of the character string A and the character string B, then returning to the step (a2); and
(a5) marking all of the characters in the character string A as different characters, and removing the different characters in the character string A to the character string C, and/or marking all of the characters in the character string B as different characters, and removing the different characters in the character string B to the character string D, in response that the length of at least one of the character string A and the character string B is zero, or the matching positions of the character string A and the character string B are both less than zero.

3. The method as claimed in claim 2, wherein the new character string A1 is the characters that follow the matched characters in the character string A, and the new character string B1 is the characters that follow the matched characters in the character string B, and the new character string C1 is the character string C adding the different characters and the matched characters in the character string A, and the new character string D1 is the character string D adding the different characters and the matched characters in the character string B.

4. The method as claimed in claim 1, wherein the comparison result list is displayed through a web page.

5. A non-transitory storage medium storing a set of instructions, the set of instructions capable of being executed by a processor to perform a method for comparing text data, the method comprising:
(a) comparing characters of a first text section in a first patent document with a corresponding second text section in a second patent document, and acquiring a same sub-character string that has a maximum matching length and matching positions of the first and second text sections, and marking characters before the matching positions of the first and second text sections as different characters; and
(b) displaying a comparison result list of the comparison between the first patent document and the second patent document on a display device.

6. The non-transitory storage medium as claimed in claim 5, wherein the step (a) comprises:
(a1) extracting the first text section recorded as a character string A from the first patent document, and extracting the corresponding second text section recorded as a character string B from the second patent document, and recording a character string C and a character string D which are both NULL;
(a2) matching characters of the character string A in the character string B in response that both of the lengths of the character string A and the character string B are greater than zero, and acquiring the same sub-character string that has the maximum matching length and matching positions of the character string A and the character string B;
(a3) marking the characters before the matching position of the character string A and the characters before the matching position of the character string B as different characters, in response that at least one of the matching positions of the character string A and the character string B is not less than zero;
(a4) acquiring a new character string A1, a new character string B1, a new character string C1 and a new character string D1 according to the maximum matching length and the matching positions of the character string A and the character string B, then returning to the step (a2); and
(a5) marking all of the characters in the character string A as different characters, and removing the different characters in the character string A to the character string C, and/or marking all of the characters in the character string B as different characters, and removing the different characters in the character string B to the character string D, in response that the length of at least one of the character string A and the character string B is zero, or the matching positions of the character string A and the character string B are both less than zero.

7. The non-transitory storage medium as claimed in claim 6, wherein the new character string A1 is the characters that follow the matched characters in the character string A, and the new character string B1 is the characters that follow the matched characters in the character string B, and the new character string C1 is the character string C adding the different characters and the matched characters in the character string A, and the new character string D1 is the character string D adding the different characters and the matched characters in the character string B.

8. The non-transitory storage medium as claimed in claim 5, wherein the comparison result list is displayed through a web page.

9. A computing device, the computing device comprising:
a storage unit;
at least one processor; and
one or more programs stored in the storage unit, executable by the at least one processor, the one or more programs comprising:
a comparison module operable to compare characters of a first text section in a first patent document with a corresponding second text section in a second patent document, and acquire a same sub-character string that has a maximum matching length and matching positions of the first and second text sections, and mark characters before the matching positions of the first and second text sections as different characters; and
a display module operable to display a comparison result list of the comparison between the first patent document and the second patent documents on a display device.

10. The computing device as claimed in claim 9, wherein the comparison module further operable to:
extract the first text section recorded as a character string A from the first patent document, and extracting the corresponding second text section recorded as a character string B from the second patent document, and record a character string C and a character string D which are both NULL;
match characters of the character string A in the character string B in response that both of the lengths of the character string A and the character string B are greater than zero, and acquire the same sub-character string that has the maximum matching length and matching positions of the character string A and the character string B;
mark the characters before the matching position of the character string A and the characters before the matching position of the character string B as different characters, in response that at least one of the matching positions of the character string A and the character string B is not less than zero;
acquire a new character string A1, a new character string B1, a new character string C1 and a new character string D1 according to the maximum matching length and the matching positions of the character string A and the character string B; and
mark all of the characters in the character string A as different characters, and remove the different characters in the character string A to the character string C, and/or mark all of the characters in the character string B as different characters, and remove the different characters in the character string B to the character string D, in response that the length of at least one of the character string A and the character string B is zero, or the matching positions of the character string A and the character string B are both less than zero.

11. The computing device as claimed in claim 10, wherein the new character string A1 is the characters that follow the matched characters in the character string A, and the new character string B1 is the characters that follow the matched characters in the character string B, and the new character string C1 is the character string C adding the different characters and the matched characters in the character string A, and the new character string D1 is the character string D adding the different characters and the matched characters in the character string B.

12. The computing device as claimed in claim 9, wherein the comparison result list is displayed through a web page.
